(19) United States
(12) Patent Application Publication
(10) Pub. No.: US 2009/0161578 A1
(43) Pub. Date: Jun. 25, 2009

(54) Data routing method and device thereof

(75) Inventors: Kenneth Wai Chung Yeung, Hong Kong (HK); Wang Cho Cheng, Hong Kong (HK)

Correspondence Address: THE NATH LAW GROUP, 112 South West Street, Alexandria, VA, 22314, US

(73) Assignee: Hong Kong Applied Science and Technology Research Institute Co. Ltd., Hong Kong (HK)

(21) Appl. No.: 12/003,282

(22) Filed: Dec. 21, 2007

(51) Int. Cl. H04L 12/28

(52) U.S. Cl. 370/254; 370/351

(57) ABSTRACT

A method for routing data through a network of devices is disclosed. Each device using the information provided by immediate neighbors 1013 dynamically determines which immediate neighbor 1013 should be the next hop to the destination 1018. The method includes the steps of (a) broadcasting by each device an outgoing route update table having entries corresponding to each immediate neighbor, each the entry including: the identity of each the immediate neighbor; the identity of each indirect neighbor that can be reached by a minimum distance through the immediate neighbor; and the minimum distance away from each the indirect neighbor through the immediate neighbor; (b) receiving by each device the outgoing route update tables as incoming route update tables; (c) renewing the outgoing route update table in each device based on incoming route update tables, wherein an entry is ignored if the identity of the immediate neighbor in said entry is identical to said device; and (d) repeating steps (a) to (c) periodically. A device for implementing the aforesaid method is also disclosed.

### RELATED APPLICATION

There are no related applications.

### TECHNICAL FIELD

The claimed invention relates to data communication between devices, and more particularly to not only a method for determining a route for routing data through a network of devices but also a device implementing such method.

### BACKGROUND ART

Currently several methods exist to perform data routing. Each tries to overcome challenges such as cost, efficiency and speed. Existing data routing methods and their limitations are discussed below.

1. Ad-hoc on demand distance vector routing (AODV)

With AODV, the route for data transmission in the network is determined on demand. In order to find the route, a host needs to know the destination address in the network. The host can then explore the network for possible routes to reach the destination by broadcasting a Routing Request (RREQ) which contains a Request ID, its own address (source address), destination address, sequence number, hop count so that others will know what the host is requesting. Upon receipt of a RREQ, an intermediate device will respond by sending a Routing Reply (RREP) if it is the destination or knows the route to the destination. Otherwise, such intermediate device rebroadcasts RREQ with hop count incremented by 1. RREQ can only be resent after a constant time and a device may retry sending RREQ for a maximum number of times. The host selects the optimal paths based on comparing the hop count to find the minimum one. The AODV routing protocol is described in greater detail in the IETF RFC 3561 protocol specification.

Drawbacks of and limitations to AODV include the need of having prior knowledge of the destination address. In addition, routing information is not available at all times but instead is retrieved on demand. The AODV method also makes routing problematic for a device because the AODV method considers all the possible routes and compares their hop counts one by one.

2. Link State Routing Protocol (LSR)

The examples for this kind of data routing method includes open shortest path first (OSPF) and optimized Link State Routing (OLSR). In a Link State Routing Protocol implementation, every device floods the entire network with the Link State Advertisement (LSA) which contains information about the immediate neighbors for each device. Upon receipt of the LSA, every device forms a graph of the whole network and runs its own shortest-path algorithm, such as Dijkstra's Algorithm, to build its routing table which records the routes to various devices in the network. In OLSR, the amount of flooding is minimized by the use of Multi-Point Relay (MPR).

Although the amount of information flooded in the network is limited to the amount of information of its immediate neighbors only, the Link State Routing Protocol requires a large amount of memory storage for each device to process data from every device in the network as well as strong computing power to compute the shortest path to each destination in the network by every device itself. LSR is an algorithm which is too complicated for a small scale deployment for a network to make use of.

3. Distributed Bellman-Ford Routing Protocol (DBF)

Unlike the Link State Routing protocol where each device collects information from all devices in the network in order to compute the routes to every device in the network, this protocol distributes the effort of information collection to other devices to reduce the workload among the devices. In the Distributed Bellman-Ford Routing Protocol, every device keeps its own routing table but sends routing updates to its immediate neighbors which are in direct connection with the device only. Such an update contains information of the metric such as hop count in order to reach various destinations. Therefore, each device collects routing information from its immediate neighbors only. Upon receipt of the routing updates from immediate neighbors, the device will then update and compute its own routing update and own routing table. The routing table contains an entry for each destination in the network. Each entry carries the metric, typically the hop count, to reach the destination as well as the immediately connecting neighbors for reaching each destination. Whereas the routing update contains only the destinations and the metric to reach to those destinations. Through the immediately connecting neighbors, the device will get to know other devices in the network which are connected to its immediately connecting neighbors according to the routing updates it receives. Then, the routing table of each device will also contain information about devices which it is not directly connected to so that its routing update will also include these further-away devices. The process keeps going on until all devices in the network have been compiled and known by each device. Each device only needs to take into account the routing table information provided by immediately connecting neighbors.

In this protocol, there is a well-known problem called the “Loop-to-infinity” problem which is illustrated as follows: when a device leaves the network or the connection to a particular device is lost, only the immediately connecting neighbors are notified and routing tables thereof are updated accordingly. Devices beyond those immediately connecting neighbors not only still have the entry of how to reach the lost device in their routing tables but also keep using this entry in their routing updates. As a result, the immediately connecting neighbors of the lost device will receive the routing updates from those devices which have not been notified that the device has been lost. Therefore, the routing updates received still contain information that the lost device can be reached in certain hop counts, making those immediately connecting neighbors of the lost device update their own routing tables accordingly that the lost device can still be reached through rerouting. As a result, this also updates other devices in the network that they are no longer the immediately connecting neighbors of the lost device and those devices using them to reach the lost devices will also update their routing tables accordingly. Such an update of route to the lost devices will never end and the lost device would exist in the route tables of the network forever.

4. Routing Information Protocol (RIP)

The Routing Information Protocol is based on the distributed Bellman-Ford protocol. This widely-implemented routing protocol is described in greater detail in the RFC 1058 (RIPv1) and RFC 1723 (RIPv2) protocol specifications. The Routing IP can carry routing information for several different protocols. The Routing Information Protocol has an express limitation that it is confined to a network size of 15 hops. A hop count of 16 means infinity (∞). It is only worthwhile using high-cost protocols for networks with lots of redundant paths such that when one path breaks, many other data pathways remain for use. As a result, for a small wired network system that does not have too many redundant paths to warrant the overhead, RIP can be a well-suited alternative for those with network size limited to those permitting a maximum of 15 hops only. RIP sends routing-update messages every 30 seconds. If the network changes, each device will update its routing table to reflect the new route. RIP uses routing-update, route-timeout and route-flush timers to regulate the performance. For this protocol, loop-to-infinity problem is converged because the maximum allowable hop counts are 16 and each device will eventually know that the lost devices can no longer be reached.

The Routing Information Protocol solves the loop-to-infinity in the following two ways. The first approach is called Split Horizon and the second approach is called Split Horizon with Poison Reverse. The problem of loop-to-infinity is due to the following scenario: In one application in a linear network of A, B and C, device B is an intermediate node between device A and device C. According to the routing table stored in device A, if device A receives any data packets with device C as the destination, device A should route such data packets to device C by forwarding those data packets to device B. This is because device A has the information that device C can be reached through device B. When device C is lost, device B will be updated on its departure since it is its immediately connecting neighbor. Since device A has not been updated with the departure of device C, device A still provides device B with the information that device C can be reached. Once this has been done, device B will update its routing table accordingly by setting the route to be B, A, B, C. Device A will also update its routing table to be A, B, A, B, C after finding that the initial route cannot reach device C. As a result, this update of route will continue forever between device A and device B in a loop that both regard the other as a way to device C. The first approach solve this loop-to-infinity problem is Split Horizon which avoid forwarding route information to the source. For example, when device A received an update from device B that device C is lost, device A will not forward any information of device C back to device B nor device A can receive from other devices that device C exists if other devices got information of device C through device A before. Therefore, after device C is lost, the information that device C is lost will propagate through the network. This works in networks that have no redundant path. The second approach is Split Horizon with Poison Reverse which works better in network that has multiple paths by announcing the information of lost device regarding of where such information is originated instead of inhibiting such an announcement, however, the device information towards the origin will have a hop count of 16.

Destination Sequenced Distance Vector Routing (DSDV)

The Destination Sequenced Distance Vector Routing method designates hop count as the metric between the device itself and the destination. This provides another way to solve the loop-to-infinity problem by including a sequence number for each entry in the routing update. In case a device is subsequently removed from the network, the immediately connecting neighbors will increment the sequence number by 1 and update the value of hop count to infinity. This entry of the lost device will never be affected by other devices because information with larger sequence number overrides those with lower ones. As a result, since the immediately connecting neighbors to the lost device will send their routing updates to other devices, other devices will be notified that the device no longer exists in the network. However, because it broadcasts more information such as the sequence number, the DSDV method requires more bandwidth than other known methods.

The currently available techniques have the following shortcomings: Ad-hoc On Demand Distance Vector routing requires knowledge of the destination address before determining the route which is not readily available; Link State Routing is a complicated algorithm which requires a lot of processing power; Distributed Bellman-Ford method has an inherent loop-to-infinity problem; even though Routing Information Protocol can address the loop-to-infinity problem, this method requires different uni-cast routing updates to different neighbors. For example, a device will send information with infinity hop count to devices in the direction towards the destination but information with actual hop count to devices in the direction away from the destination. Destination Sequenced Distance Vector routing has the overhead of using sequence number to solve loop-to-infinity problem.

### SUMMARY OF THE INVENTION

Accordingly, the claimed invention has been developed with a view to substantially eliminating the drawbacks inherent in the prior art.

The claimed invention teaches an improved data routing method using a routing method with reduced overhead. The method allows a network device to collect routing information from its immediately connecting neighbors which are also known as immediate neighbors. For those remote devices which cannot be reached in one hop but can only be reached through other intermediate devices, those remote devices are also known to be indirect neighbors. The device knows immediately how to send the data to the destination device if the destination device is one of its immediate neighbors while for those indirect neighbors which are not connected directly to the device, the device will perform an internal check to determine the indirect neighbor can be reached through which immediate neighbors. Instead of compiling a global route map before sending a data packet, the device only knows what the next hop will be in order to reach the destination. Once the data is forwarded to the immediate neighbor, the remaining steps will be taken care by subsequent devices in every subsequent hop. Since the device keeps a routing table which states the next hop for each possible destination, the route need not be determined on demand like the AODV routing method. Using the claimed method, the device does not need to store as much information as the existing algorithms like LSR which store the whole topology of the network. Neither does it require the device to compute the shortest path for every single destination. The device no longer takes a global view over the network such that even if the network changes, the changes in intermediate devices to the destination may be transparent to that device as long as the next hop and the destination is not affected, unlike the algorithms where devices carrying the whole routes have to update whenever any device along any route are affected.

Unlike Distributed Bellman Ford Routing Protocol, the claimed invention has no loop-to-infinity problem. A device will simply ignore any update of indirect neighbors' routing information which is in fact given by the device itself. If the device is actually closer to some neighboring devices, it will have more updated routing information. If some other neighbors inform the device that those neighboring devices are gone, the device will still keep the updated routing information and avoid being misled by those which actually learn about the existence of these neighboring devices through the device itself. Unlike the RIP protocol, this method allows device to use the same route update information to notify all the immediate neighbors instead of individually determining what the route information of a particular device should be sent or if the hop count should be set to be infinity.

The presently claimed invention further discloses a device which keeps a routing table and sends route update information to its immediate neighbors as well as how the device maintain such routing table and route update information. The route update information of the device is sent to its immediate neighbors so that others know what other devices can be reached through the device. This piece of information is sent to all immediate neighboring devices preferably in a single broadcast instead of sending it to neighboring devices one at a time. In a wireless network embodiment, broadcasting can be achieved by asking all devices to listen to the same radio channel at a specific time interval. In a wired network, broadcasting can be done by sending the information through various ports with each neighboring device listening to a different port. In a peer-to-peer connection, the claimed invention makes communication possible without the need of a dedicated wireless hub/router acting as a central station and enables the operation of a small scale ad-hoc wireless personal area network (WPAN) through its implementation.

Other objects of the claimed invention besides the aforesaid shall be apparent to those skilled in the art according to the appending descriptions, drawings and claims.

### BRIEF DESCRIPTION OF THE DRAWINGS

FIG. 1A shows a route update cycle for the implementation of the claimed invention under the Wimedia distributed MAC (Media Access Control) protocol over UWB (Ultra-Wideband).

FIG. 1B shows a network of device A, device B and device C.

FIG. 1C shows an exemplary illustration for a data packet.

FIG. 2 shows a flow diagram of how the route update is performed under the claimed invention.

FIG. 3 shows a schematic block diagram of the device of the claimed invention.

FIG. 4A shows an example of Route Update Table.

FIG. 4B shows an example of Routing Table.

FIG. 4C shows an example of Route Update Table of device A in a network of devices A, K, L, M and N.

FIG. 5A shows a network for a device A, and it is used to show how the Route Update Table and the Routing Table for device A will look like in such a network.

FIG. 5B shows the Route Update Table to be broadcasted by device A.

FIG. 5C shows the Routing Table stored and maintained by device A.

FIG. 6A shows a flow diagram of how a device updates its Route Update Table.

FIG. 6B shows a network for illustrating how device A updates its Route Update Table after joining to a network of device B and device C.

FIG. 6C shows a network for illustrating how device A updates its Route Update Table after joining to a network of device B, device C and device D.

FIG. 7 shows the flow diagram of how to maintain the indirect neighbor entries for a device.

FIG. 8A shows the network with device A alone.

FIG. 8B shows the network with devices A, B in an example that device B is directly connected to device A.

FIG. 8C shows the network with devices A, B, C in an example where device C joins the network of devices A and B.

FIG. 9 shows the structure of the route update information to be transmitted to directly connected devices.

FIG. 10A shows an example of a linear network and the Route Update Table stored by device C.

FIG. 10B shows the byte structure of what is transmitted by device C to its directly connected devices.

### DETAILED DESCRIPTION OF THE INVENTION

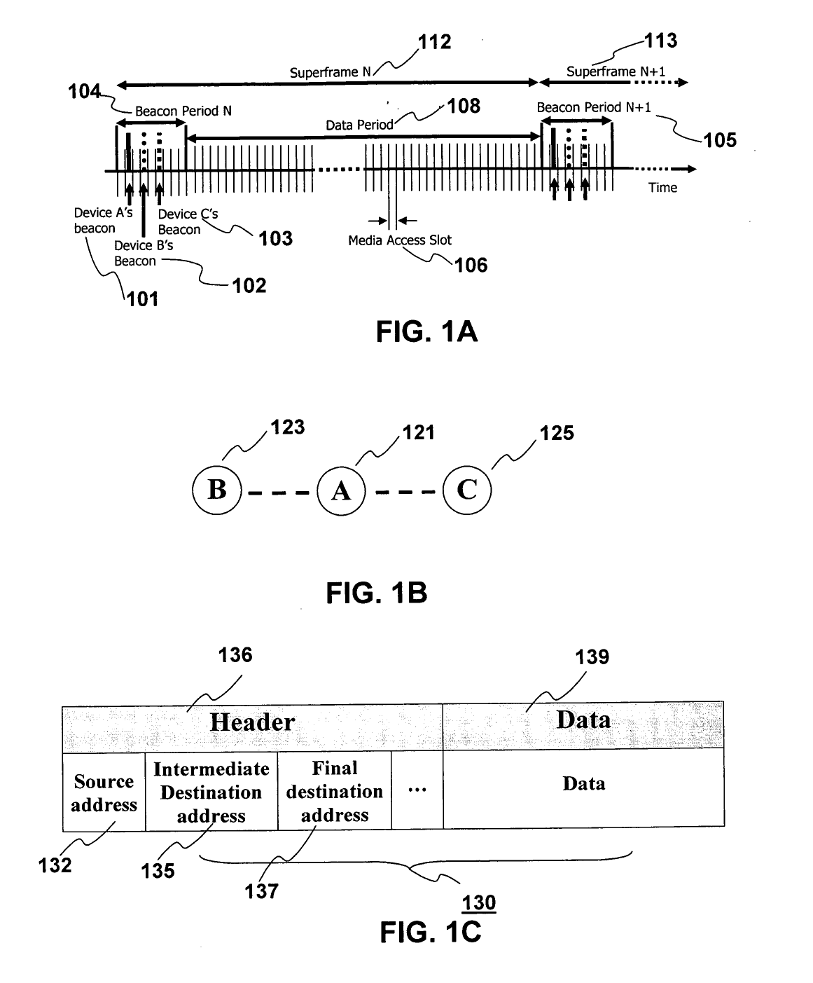

FIG. 1 depicts the layout of a simple representative network. In FIG. 1B, device A 121 is connected to immediate neighbor devices B 123 and C 125. When devices fall within a proximity to one another, they will form a network by communicating with each other. According to the claimed invention, a device will only talk with immediate neighbors, which it is directly connected to, and get to know other indirect neighbors, which a device needs to take more than 1 hop to reach, through these immediate neighbors.

FIG. 1A shows the timeline of how routing information can be shared among various devices. Devices exchange information with each other through beacons 101, 102, 103 to learn about the existence of all devices in the network, also known to be neighbors, which includes immediate neighbors directly connected with the device and indirect neighbors connected with the device indirectly via other devices. When devices A, B, C are in proximity to each other as immediate neighbors, each will send information to the other immediate neighbors during the beacon period 104 once the communication links are established among them. In other embodiments, devices can exchange information at any time other than during the beacon period 104. Representative communication link types include wireless link such as radio link, Bluetooth link or infrared as well as wired link such as copper cable or optical fiber. The information is the route update information stored by each device or Route_update in short. As an example of implementation under the Wimedia distributed MAC protocol over UWB as illustrated in FIG. 1, the routing update is performed every superframe 112 during the beacon period (BP) 104 as defined in Wimedia distributed MAC specification. A superframe 112 is 65536 microseconds and the period is divided into 256 Media Allocation Slots 106 (MAS). Each MAS 106 is 256 microseconds long. The superframe 112 is made up of the beacon period 104 and the data period 108. The beacon period 104 refers to the first few MAS 106 after the start of the superframe 112. The routing update message can be implemented as ASIE (Application Specific Information Element) in a beacon 101, 102, 103, thus support from those International Standards Bodies is not mandatory. Beacons 101, 102, 103 are broadcasted to all devices within the communication range during beacon periods 104, 105. An ASIE (called Route_update) containing the route update information is added in beacons 101.

Every device receives all other devices beacons 101, 102, 103 during the beacon period N 104. At the end of beacon period N 104, the device will have readily determined what to send in the next beacon period N+1 105. The routing update is done in a synchronous way. That means all devices are synchronous to each other and the route update happens in the same beacon period viewed by all devices. After the exchange of the route update information, each device would have known how to route the data to the destinations and data communication will take place during the following period known as data period 108. Some variations on the implementation can be but not limited to the following:

1. There is no need to have route update very often. The periodic update period can be longer. For example, the Route_update need not be sent in every superframe 112 but can be exchanged every second (i.e. about 15 superframes). Then the broadcast of the route update information can be less often per period of time. Of course, the time to reach a stable routing condition would also be longer.

2. The route update information can be carried through command frames during the data period 108 rather than the beacon period 104 so that larger route update information can be carried.

3. The synchronous route update is not mandatory. Asynchronous route update is also an alternate embodiment.

As a result, during the beacon period 104, devices in the network will exchange the information to build up its own routing table in each device. Then during the data period 108, data transfer can be accomplished according to the routing tables. As shown in FIG. 1C, data are sent in form of data packet 130 and each data packet 130 contains the source address 132, the intermediate destination address 135 and the final destination address 137 in its header 136. If a device want to send a data packet 130 to any indirect neighbor, it should look up its own routing table to find out the next hop destination and use it to fill in the intermediate destination address 135. The source address 132 is just the identifier of the device and the final destination address 137 is the identifier of the indirect neighbor. The following figures illustrate not only how the route update information is being built and updated but also what information should be exchanged among devices in order to build and update their own route update information.

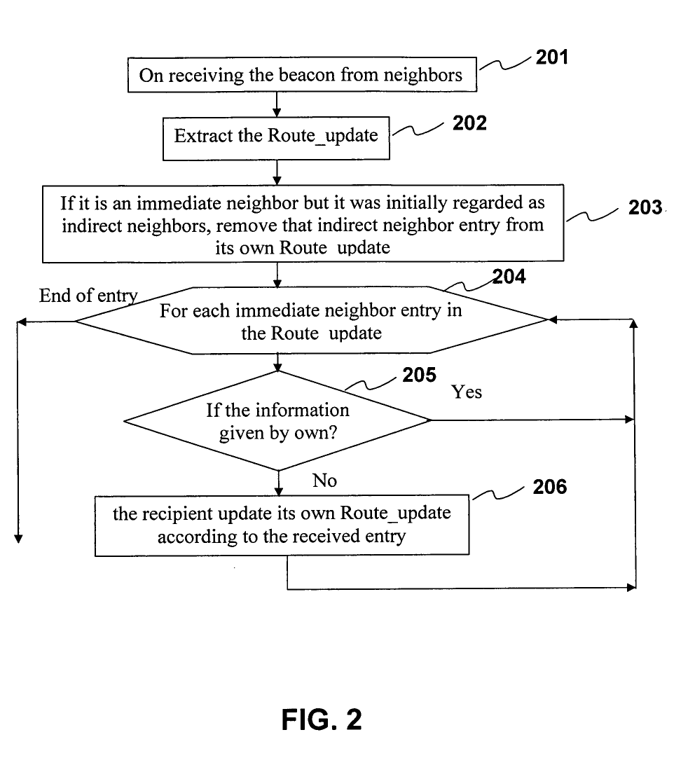

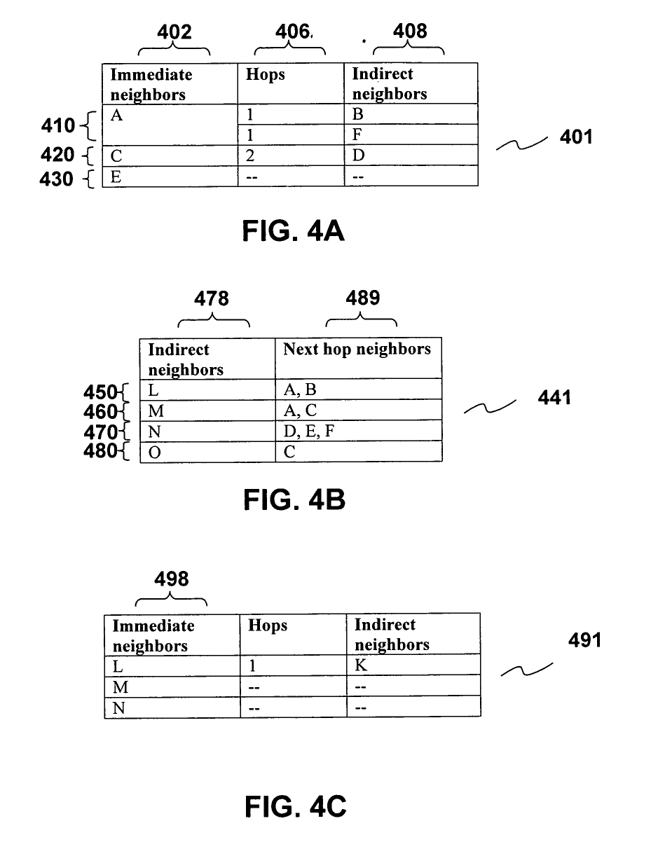

FIG. 2 shows a high-level flow chart of what steps a device will perform to determine its route update information and routing table upon receiving the beacon from its immediate neighbor in the beacon receiving step 201. It will then be followed by the information extracting step 202, during which a device will extract the route update information, known as Route_update, from the beacon. Then a device will check the route update information in the status renewal step 203 to see if any devices which were initially regarded as indirect neighbors have come closer and should now be treated as immediate neighbors. If any indirect neighbor has now become an immediate neighbor of the device, the device will remove this initially indirect neighbor from its indirect neighbor entries before putting this approaching device into its immediate neighbor list. Then, for each of its immediate neighbor, the device will check each entry in the route update information in the scanning step 204. Since the entries in the route update information are grouped under each immediate neighbor, the device can tell the entry information is provided by itself if the entry uses the device itself as an immediate neighbor. If any entry is given by the device itself, the device will simply ignore it and go to next entry as shown in the information filtering step 205. If the entry is not provided by the device itself, the device will update its route update information and its routing table according to the entry in the update step 206. Details of Route Update table and Routing Table will be further described below in FIGS. 4A, 4B.

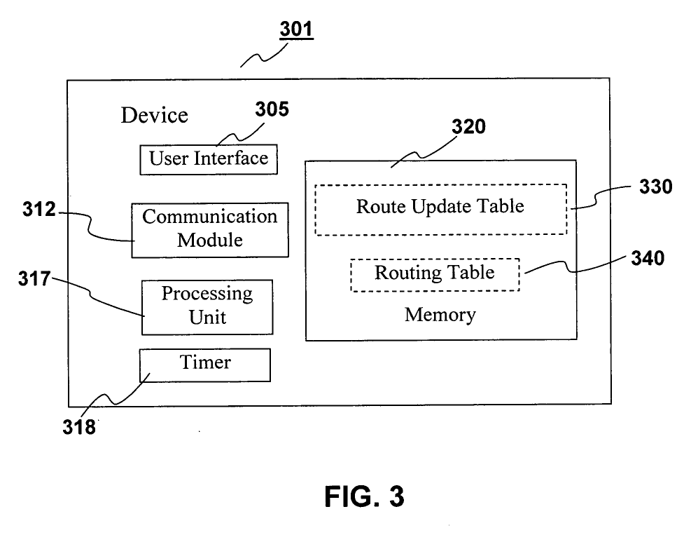

In order to further illustrate the method of the claimed invention, FIG. 3 illustrates an implementation of the aforesaid method. The schematic view of the device 301 in FIG. 3 depicts what is being stored and updated by the device 301 when implementing the method. The device 301 contains a user interface 305 for user to manipulate the device 301 and interact with it. User interface 305 can be any output devices such as a display, speaker or any input devices such as keyboard, touch-screen input device. Device 301 also includes a memory 320 which can store all the information under process and contains 2 data structures in particular: a Route Update Table 330 and a Routing Table 340. In order to communicate with other devices, the device contains communication module 312 which can exchange information with other devices. Such a communication module 312 may also be capable of any encoding, decoding, modulation, demodulation and any signal processing functions. The communication module 312 broadcasts information including a Route Update Table 330. The Route Update Table 330 is stored in the memory 320 as a first memory unit. The content of the Route Update Table 330 includes the identity of each immediate neighbor of the device 301, the identity of each indirect neighbor that can be reached by a minimum distance through the immediate neighbor, and the minimum distance away from each indirect neighbor through said immediate neighbor. The communication module 312 receives Route Update Tables form other neighboring devices. In the meantime, the device 301 also maintains a routing table 340 in the memory 320 as a second memory unit. The device 301 also possesses a processing unit 317 to carry out all the computation and execution of instructions. Such a processing unit 317 controls all the components inside the device 301. In particular, the processing unit 317 renews the route update table 330 in the memory 320 according to Route Update Tables received from other devices. The processing unit 317 also updates the content of the Routing Tables 340 which contains entries corresponding to all other devices in the network including immediate neighbors as well as indirect neighbors. Each entry includes information about the other device and the identity of the next hop the device 301 needs to take in order to reach this other device in a minimum distance. The device 301 further has a timer 318 for counting a predetermined length of time after a device detects an immediate neighbor has left while the processing unit 317 further performs the task of holding down when the timer 318 is counting, such that any information in received Route Update Tables corresponding to the departed immediate neighbor is ignored. The processing unit 317 also retrieves destination information for a data packet and looks up an entry in the Routing Table for indirect neighbor that matches said destination information. The processing unit 317 determines the immediate neighbor as a next stop from said entry and forwards the data packet to an immediate neighbor. The device 317 performs network communication by a protocol selected from a group of protocols consisting of Wimedia, distributed MAC protocol over UWB, WiFi, Zigbee and Bluetooth. The Route Update Table 330 and the Routing Table 340 have different structures as follows:

1. Route Update Table

Route Update Table 401 contains the route update information for sending to neighbors, such as in a broadcast message. An arbitrary example is illustrated in FIG. 4A. Each immediate neighbor entry 410, 420, 430 in the table contains the following information regarding the route: Immediate neighbor 402, Hop count 406, Indirect neighbor 408. The indirect neighbor 408 in such an entry can be regarded as the destination that the device would like to reach through this route and the immediate neighbor 402 is the immediately connecting neighbor to the device through which the indirect neighbor can be reached. The Hop count 406 is the number of hops the device takes to reach the indirect neighbor 408 from the immediate neighbor 402. In the example given by FIG. 4A, entry 410 tells other devices that when they need to reach device B and device F, they have to go through device A from which it takes another 1 hop to reach device B and device F respectively. The Route Update Table 401 also shows that the device which stores this Route Update Table 401 has 3 immediately connecting neighbors which are device A, device C and device E respectively.

2. Routing Table

Routing Table 441 is stored internally in each device and it contains a list of indirect neighbors 478 which cannot be reached immediately within 1 hop. Corresponding to each indirect neighbor there is a list of immediately connecting neighbors, i.e. next hop devices 489, through which the indirect neighbors can be reached. For example in FIG. 4B, device L, device M, device N and device O are indirect neighbors which are not directly connected to the device which maintains such Routing Table 441. Therefore, in order for the device to reach device L for instance, the device has to go through the immediate neighbors, which can be either device A or device B in this example.

Each device allows other neighboring devices to prepare their Routing Tables 340 and their Route Update Table 330 by broadcasting its own Route Update Table 330, also known as outgoing Route Update Table, to its immediately connecting devices. Those immediately connecting devices regard the Route Update Table in receipt as incoming Route Update Table. Since it is essential for the route update information to be broadcasted to all immediate neighbors, it is necessary to send the same broadcast message to different devices through different ports in a situation of wired network. In a preferred embodiment in a wireless network, the broadcast action can simply be implemented by conveying the message to the appropriate radio channel while all the immediate neighbors are listening to this radio channel. As in the example of FIG. 4B, a device knows how to reach the indirect neighbors and can decide which device e.g. device A or device B as a next stop in order to reach device L. In the case that there exist more than one next hop neighbors, it means that the same distance is required to reach a destination no matter which next hop neighbors is gone through.

While preparing the Route Update Table 330 to be broadcasted to neighboring devices, a device may find different routes to reach the same indirect neighbor. In order to reduce the redundancy, only the one with the shortest distance, i.e. minimum hop count, will be forwarded and carried on by the Route Update Table 330. In the very beginning, it is supposed that there is only one device in the network and such device will not broadcast any route update information because there is no immediate neighbor. After the device discovers an immediate neighbor, it starts broadcasting route update information to its immediate neighbors. When a device receives route update information from another device, it will examine the route update information and may increment the hop count for each entry by 1 before broadcasting its route update information to its immediate neighbors. Also, the device will only choose the route update information which yields a minimum distance. For example, if device A knows from that it can reach device K in 1 further hop from device L, 2 further hops from device M and 3 further hops from device N, device A will only carry and forward the route update information of reaching device K in 1 hop via device L which indicates a minimum distance to other neighbors.

Each device not only announces a distance it takes to reach each destination, typically in term of hop counts, but also ties each destination with a next hop neighbor for said device through which said device can reach the destination. An example of what is stored in device A's Route Update Table 330 is illustrated in FIG. 4C, which contains only the information of those immediately connecting neighbors and the minimum distance required to reach device K via device L. The recipient of such Route Update Table 491 can then check whether the distance information is in fact given by itself because if it is so, the recipient will find itself linked with the destination information as the next immediate hop, i.e. the device will find itself appears as immediate neighbors 498. So in this case, when device L receives the broadcast message of Route Update Table 491 from device A, it will not interpret the information that device L can reach device K through device A. Device L will only take into consideration of the information that device M and device N are immediate neighbors of device A.

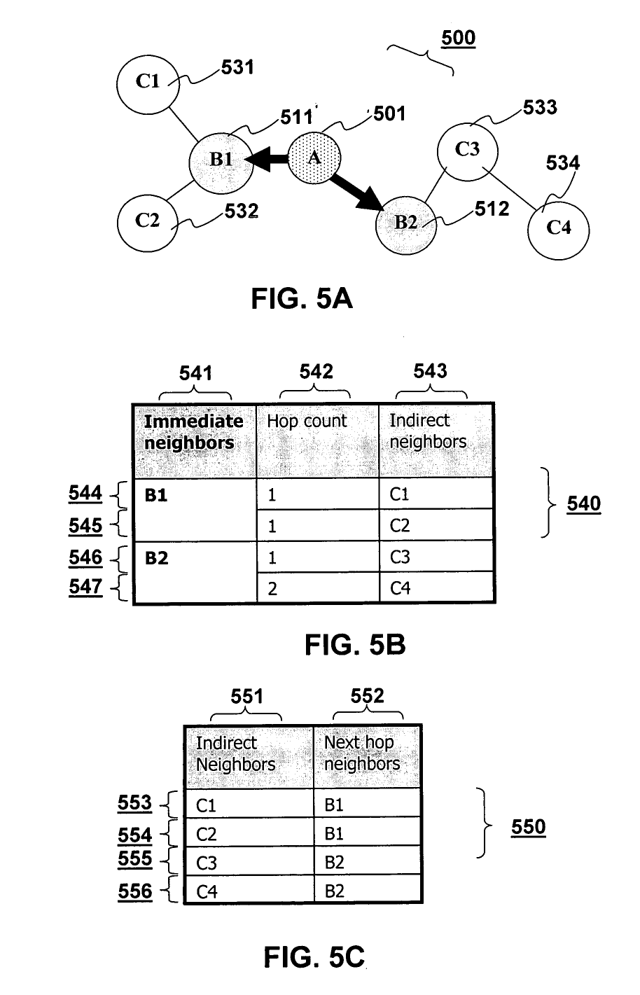

FIG. 5A shows a network 500. There is a device A 501 in this network 500. This device A 501 will be used as an example to illustrate what the Route Update Table and the Routing Table are if device A 501 is situated in such network 500. As shown in FIG. 5A, device A 501 immediately connects directly with two immediate neighbors which are device B1 511 and device B2 512 respectively. Therefore, device B 1 511 can communicate with device A 501 in one hop and device B2 512 can also communicate with device A 501 in one hop. Device C1 531 immediately connects with device B1 511 but is not directly connected with device A 501. Therefore, device C1 531 is an indirect neighbor of device A 501, and device C1 531 can communicate with device A 501 through device B1 511 in two hops. Device C2 532 immediately connects with device B1 511 but is not directly connected with device A 501. Therefore, device C2 532 is an indirect neighbor of device A 501, and device C2 532 can communicate with device A 501 through device B1 511 in two hops. Device C3 533 immediately connects with device B2 512 but is not directly connected with device A 501. Therefore, device C3 533 is an indirect neighbor of device A 501, and device C3 533 can communicate with device A 501 through device B2 512 in two hops. Device C4 534 immediately connects with device C3 533 but is not directly connected with device A 501. Therefore, device C4 534 is an indirect neighbor of device A 501, and device C4 534 can communicate with device A 501 in three hops by going through device C3 533 and then device B2 512.

FIG. 5B shows the Route Update Table 540 of device A 501 corresponding to the network 500 of FIG. 5A. Each entry in this Route Update Table 540 has three fields: i) the identity of immediate neighbors 541, ii) hop count 542, representing the distance between the immediate neighbor in i) and the indirect neighbor in iii) below, and iii) the identity of indirect neighbors 543. For device A 501 in the network 500, there are 4 entries in the Route Update Table 540 of device A 501. The entry 544 has the identity information of device B1 511 as the immediate neighbors, identity information of device C1 531 as the indirect neighbors and a hop count value of one. The entry 545 has the identity information of device B1 511 as the immediate neighbors, identity information of device C2 532 as the indirect neighbors and a hop count value of one. The entry 546 has the identity information of device B2 512 as the immediate neighbors, identity information of device C3 533 as the indirect neighbors and a hop count value of one. The entry 547 has the identity information of device B2 512 as the immediate neighbors, identity information of device C4 534 as the indirect neighbors and a hop count value of two.

FIG. SC shows the Routing Table 550 of device A 501 corresponding to the network 500 of FIG. 5A. Each entry in this Routing Table 550 of device A 501 will have two attributes which are i) the identity of indirect neighbors and ii) the identity of the immediately connected next hop neighbors through which the corresponding indirect neighbor in i) can be reached by the shortest path. All the possible destinations which can be reached by device A 501 are stored as individual entries in the Routing Table 550, including device C1 531, device C2 532, device C3 533 and device C4 534. For device C1 531, there is an entry 553 with the identity information of device C1 531 as the indirect neighbors and the identity information of device B1 511 as the next hop neighbors. For device C2 532, there is an entry 554 with the identity information of device C2 532 as the indirect neighbors and the identity information of B1 511 as the next hop neighbors. For device C3 533, there is an entry 555 with the identity information of device C3 533 as the indirect neighbors and the identity information of device B2 512 as the next hop neighbors. For device C4 534, there is an entry 556 with the identity information of device C4 534 as the indirect neighbors and the identity information of device B2 512 as the next hop neighbors.

The claimed invention eliminates the loop-to-infinity problem as follows; If a destination device is lost, then all the immediately connecting devices thereof will instantly be notified and update their Route Update Table and Routing Table accordingly. At the same time, those immediate neighbors of the lost destination device which are the intermediate device between the lost destination device and the devices which are 2 hops away from the lost devices will also receive from these devices the Route Update Table which provides the obsolete destination information about the lost destination which was obtained from those immediate neighbors of the lost destination device earlier. From the Route Update Table, said neighbor devices will find that they themselves will be the next-hop devices so that they know the destination information received is in fact provided by themselves earlier and should be ignored and instead, the devices keep propagating the newly updated information about the lost device to other devices.

In some network configurations with loops, the loop-to-infinity problem due to the leaving of a device could still occur even with the rule that any information originated from itself will be ignored. Therefore a hold down mechanism is employed by this method. The hold down mechanism in the claimed invention works as follows: Whenever a device detects an immediate neighbor has left, the device starts a timer. Until the duration set by the timer is over, the device ignores the existence of indirect neighbors which are obtained from the Route Update Table received from indirect neighbors which still keep the information of what have been detected as lost. This is to make sure the network gets enough time to share the information of the lost device instead of being confused by the obsolete information floating around.

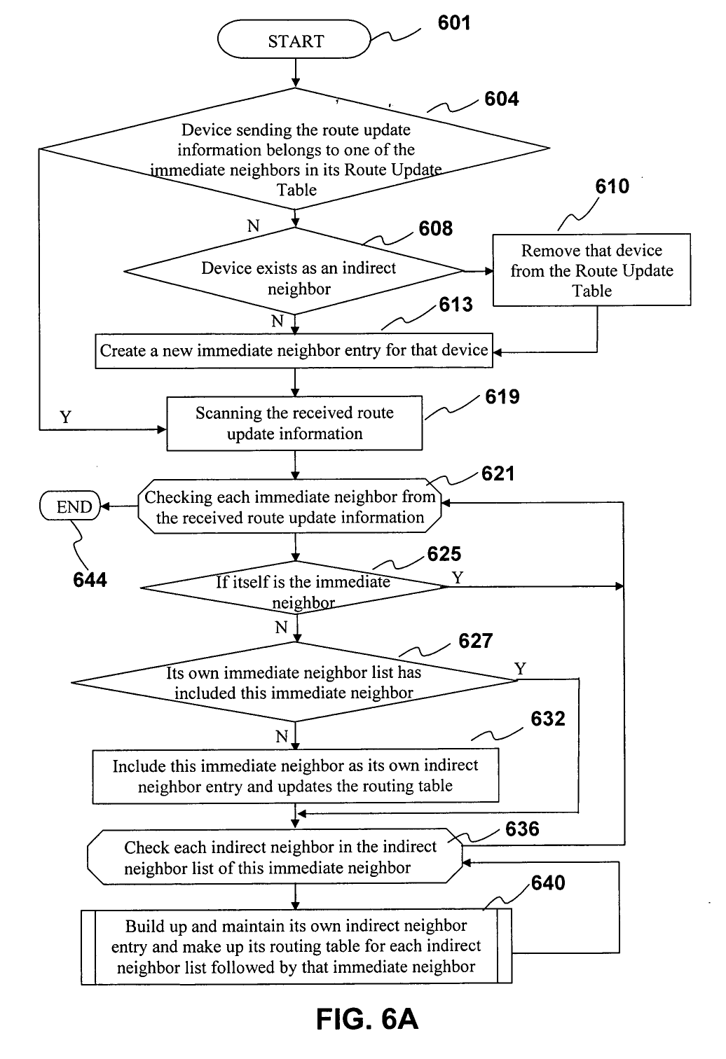

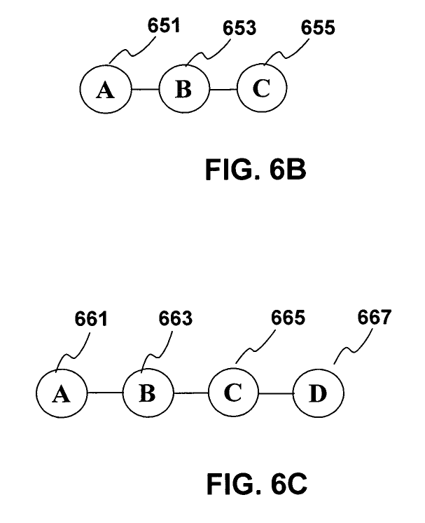

FIG. 6A is a detailed flow chart illustrating how the Route Update Table is handled upon receipt. After receiving the Route Update Table from a sender device, a recipient device will check from its own Route Update Table. By looking at its own Route Update Table, the recipient device knows if the sender device belongs to one of its immediate neighbors through the immediate neighbor identifying step 604. If it is so, the immediate neighbor identifying step 604 will directly jump to the scanning step 619 to scan the entries of this known immediate neighbor in order to update the Route Update Table of the recipient device. If the sender device has neither been recorded in the Route Update Table of the recipient device nor been listed as an indirect neighbor in the same table, an immediate neighbor entry is created for it. But if it is found in the indirect neighbor identifying step 608 that the device has been existing as a indirect neighbor in the Route Update Table of the recipient device, that means now it gets closer to the recipient device and needs to have its entry as an indirect neighbor removed from the Route Update Table of the recipient device in the eliminating step 610. Then, a new immediate neighbor entry will be created for it in the new entry creation step 613.

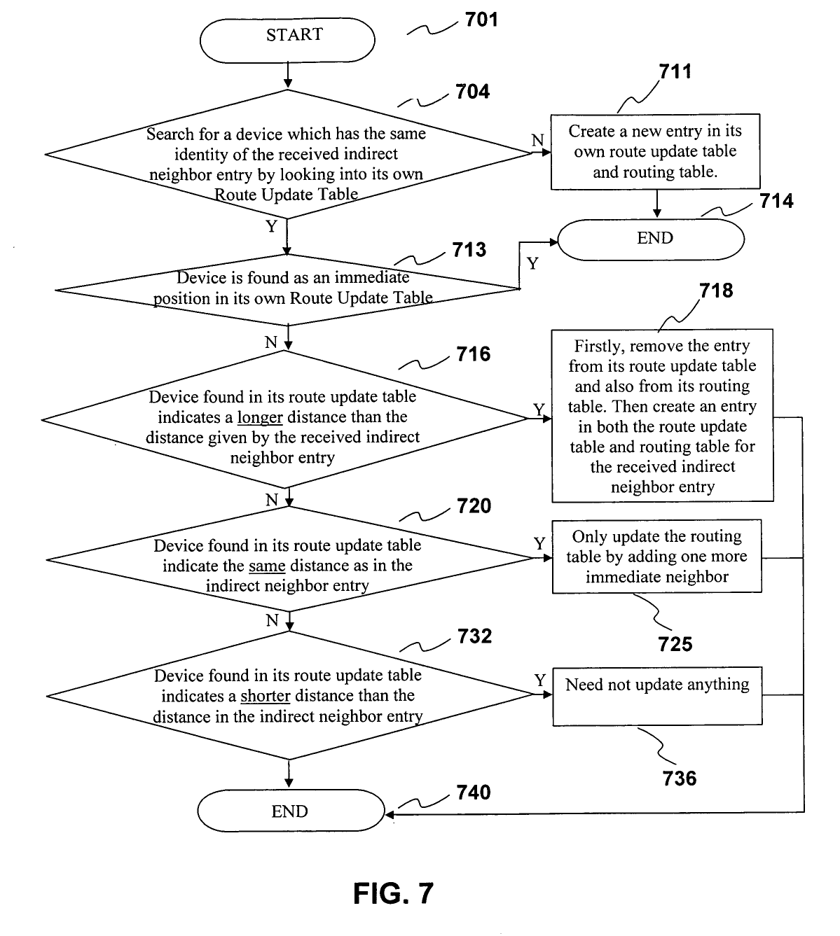

In the scanning step 619, the route update information provided in the Route Update Table of the sender device will be scanned. Every single immediate neighbor according to that route update information will be checked in the checking step 625 one immediate neighbor entry by one immediate neighbor entry. If the recipient device finds that the immediate neighbor entry is itself in the identification step 625, the process will go on to check another immediate neighbor entry from the route update information. After making sure that the immediate neighbor entry is not itself, the recipient device would further make sure that the immediate neighbor entry in the Route Update Table from the sender device has not been included as the immediate neighbor entry of the recipient device in the distinguishing step 627. If the immediate neighbor entry from the route update information has not been recorded by the recipient device, then it will be included as an indirect neighbor entry of the recipient device for its Route Update Table in step 632. Accordingly, the Routing Table will also be updated in the neighbor entry update step 632. Furthermore, in the indirect neighbor entry examination step 636, the indirect neighbors followed by each immediate neighbor entry will also be examined so as to build up and maintain the recipient device's indirect neighbor entries in the Route Update Table and make up the Routing Table thereof in the build-up step 640. The detailed procedure inside the build-up step 640 will be further illustrated in the flow chart in FIG. 7. The update process will go on until all the immediate neighbor entries and indirect neighbor entries in the route update information provided by immediate neighbors of the recipient device have been scanned, then the update process will come to an end in the ending step 644.

For illustration, FIG. 6B shows an example in which a device A 651 joins a network of device B 653 and device C 655 after device A 651 gets closer to device B 653. Device C 655 is an immediate neighbor of device B 653. Device A 651 confirms device B 653 as an immediate neighbor which is neither its immediate neighbor before in the immediate neighbor identifying step 604 nor its indirect neighbor in the indirect neighbor identifying step 608. Therefore, a new immediate neighbor entry is created for device B 653 by device A 651. Then device A 651 will scan the route update information from device B 653 in the scanning step 619. Then all the immediate neighbors of device B 653 will be checked in the checking step 621 and device B 653 only has an immediate neighbor of device C 655. Device A 651 will confirm that the immediate neighbor entry about device C 655 is neither device A 651 itself in the identification step 625 nor known to device A 651 before in the distinguishing step 627. Therefore, device C 655 can be included as an indirect neighbor entry for device A 651 in the neighbor entry update step 632 and the route update table as well as the routing table of device A 651 will be updated. Then device A 651 will go on to check the indirect neighbor entry of device B 653 in the indirect neighbor entry examination step 636. Since there is no indirect neighbor of device B 653, the process will go back to the checking step 621 to check next immediate neighbor entry of device B 653. Since device B 653 has no other immediate or indirect neighbor entries, the route update process for device A 651 will come to an end in the end step 644.

For illustration, FIG. 6C shows an example in which a device A 661 joins a network of device B 663, device C 665 and device D 667 after device A 661 gets closer to device B 663. The only thing which is different from the previous illustration in the preceding paragraph is that device B 663 has an indirect neighbor device D 667. In this case, device A 661 will proceed to process the indirect neighbor entry in the build up step 640. Device D 667 will be an indirect neighbor entry for device A 661 before device A 661 goes on to check if there is any other indirect neighbor entry of device B 663 in connection with device C 665 in the indirect neighbor entry examination step 636. Since no other indirect neighbor entries are available, the process will proceed back to the checking step 621 to check if there is any other immediate neighbor entry of device B 663. Since device B 663 has no other immediate or indirect neighbor entries, the route update process for device A 661 will come to an end in the end step 644.

FIG. 7 is the expanded view of the build up step 640. It illustrates the way of maintaining the Route Update Table and maintaining an up-to-date Routing Table in a recipient device. Starting from the start step 701, the recipient device will search in its own Route Update Table for a device which has the same identity of the received indirect neighbor entry in the device checking step 704. If such a device cannot be found in this device checking step 704, a new entry of indirect neighbor which can be reached through the immediate neighbor sending the route update information will be created in its Route Update Table and Routing Table for the recipient device in the entry creation step 711 before the process ends at the ending step 714. In the entry creation step 711, the hop count will also be incremented by one for the recipient device to reach this new indirect neighbor through its immediate neighbor sending this piece of information. If such a device cannot be found in its Route Update Table as a direct neighbor in the direct neighbor checking step 713, then the process proceeds to an analysis of 3 possible scenarios in which either the existing route to the indirect neighbor in the recipient device is a longer one, a shorter one or the same when compared with the new route by taking the device which send the route update information as an intermediate device. If such a device can be found in its Route Update Table as a direct neighbor in the direct neighbor checking step 713, the process will come to an end at the ending step 714.

1) Long scenario step 716: If the device finds in its Route Update Table indicates a longer distance than the distance given by the received indirect neighbor entry, then firstly remove the entry from its Route Update Table and also from its Routing Table. Then create an entry in both the Route Update Table and Routing Table for the received indirect neighbor entry, adopting a new route to this indirect neighbor through the immediate neighbor which sends the route update information in first update step 718. After that, the process will come to an end at the ending step 714.

2) Equal scenario step 720: If the device found in its Route Update Table indicate the same distance as in the indirect neighbor entry, then only update the Routing Table by adding one more immediate neighbors in second update step 725. After that, the process will come to an end at the ending step 714.

3) Short scenario step 732: If the device found in its Route Update Table indicates a shorter distance than the distance in the indirect neighbor entry, then no need to update anything as in third update step 736. After that, the process will come to an end at the ending step 714.

After the 3 scenario check, the process will end at the termination step 740. Since every device only carries and forward the shortest path information received from neighbors, the routes stored in the Routing Table contains only the next stop which can yield a shortest route to a destination. Every device does not have the whole picture for any shortest path. Instead, the shortest path is found on the way.

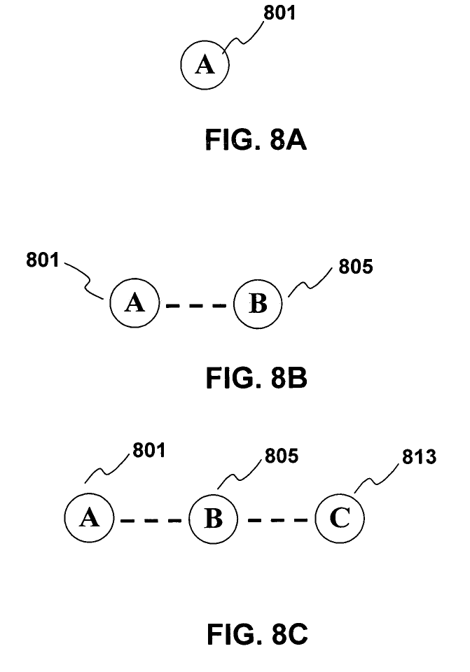

In FIG. 8, an example will be used to illustrate how the claimed invention works and handles situations like adding a new device and the leaving of an existing device. In the beginning,

Device A 801 is alone

Device A

| Route Update Table | | |
|---|---|---|
| Immediate | Indirect | Routing Table |

| neighbors | Hop | neighbors | Destination | Next stop |
|---|---|---|---|---|
| — | — | — | — | — |

FIG. 8A shows that device A 801 is alone and the only device in the network. The Routing Table and the Route Update Table for device A is empty at that moment as shown in Table 1 above. No immediate or indirect neighbors are around or known to device A.

Device B 805 joins the network of device A 801

TABLE 2
Device A

| Route Update Table | | |
|---|---|---|
| Immediate | Indirect | Routing Table |

| neighbors | Hop | neighbors | Destination | Next stop |
|---|---|---|---|---|
| B | — | — | — | — |

TABLE 3
Device B

| Route Update Table | | |
|---|---|---|
| Immediate | Indirect | Routing Table |

| neighbors | Hop | neighbors | Destination | Next stop |
|---|---|---|---|---|
| A | — | — | — | — |

FIG. 8B shows that device B 805 gets close to device A 801 and from a direct connection with device A 801. Table 2 shows the resulting Route Update Table and Routing Table of device A 801 and Table 3 shows those for device B 805 after they gather information from each other and update these tables accordingly. Device B 805 comes close to device A 801 and is connected with device A 801 in a network. Firstly, device A 801 discovers device B 805 to be close enough to be its immediate neighbor. Then device A 801 will check if device B 805 has been its indirect neighbor or not. If device B 805 can be found in the routing information of device A 801, such an entry as a indirect neighbor will be deleted and a new entry as an immediate neighbor of device A 801 will be generated for device B 805. Similarly, device A 801 will broadcast its route update information to device B 805 as they are now in proximity and become connected. Device B 805 will work in a way that is the same as what has been described for device A 801. As a result, device A 801 will be recorded as an immediate neighbor in the Route Update Table of device B 805.

Device C 813 joins the network of device A 801 and device B 805

TABLE 4
Device A

| Route Update Table | | |
|---|---|---|
| Immediate | Indirect | Routing Table |

| neighbors | Hop | neighbors | Destination | Next stop |
|---|---|---|---|---|
| B | 1 | C | C | B |

TABLE 5
Device B

| Route Update Table | | |
|---|---|---|
| Immediate | Indirect | Routing Table |

| neighbors | Hop | neighbors | Destination | Next stop |
|---|---|---|---|---|
| A | — | — | — | — |
| C | — | — | — | — |

TABLE 6
Device C

| Route Update Table | | |
|---|---|---|
| Immediate | Indirect | Routing Table |

| neighbors | Hop | neighbors | Destination | Next stop |
|---|---|---|---|---|
| B | 1 | A | A | B |

FIG. 8C shows that device C 813 joins the existing network of device A 801 and device B 805 while device C 813 forms a direct linkage with device B 805 but can only reach device A 801 through device B 805. After these devices gather information from each other and update these tables accordingly, the resulting Route Update Table and Routing Table of device A 801, device B 805 and device C 813 are shown in Table 4, Table 5 and Table 6 respectively. The situation is to add device C 813 into the network with device B 805 in the middle between device A 801 and device C 813. Device C 813 will broadcast the route update information to device B 805, making device B 805 register device C 813 as a new immediate neighbor entry in the Route Update Table of device B 805. While for device C 813, it will get the route update information form device B 805 and makes a new immediate neighbor entry for device B 805 as device B 805 exists in neither Route Update Table nor Routing Table of device C 813. The immediate neighbors of device B 805 will then be added as indirect neighbors of device C 813. As one of the immediate neighbors of device B 805 is device C 813 itself, this entry in the route update information from device B 805 need not be considered. Therefore, in the Route Update Table of device C 813, device A will become an indirect neighbor entry under device B 805 and it takes 1 hop to reach device A 801 from device B 805. A new destination entry will be added to the Routing Table of device C 813, recording device A 801 as the destination and device B 805 is the next hop of device C 813 to reach that particular destination. Regarding the Route Update Table and Routing Table of device A 801, device A 801 will update them after receiving the latest route update information from device B 805. Since device C 813 is an immediate neighbor of device B 805, device A 801 will check if device C 813 is also an immediate neighbor of itself and add device under the entry of device B 805 as an indirect neighbor of device A 801 which is 1 hop from device B 805 in the Route Update Table. Moreover, the routing table will be updated accordingly with device C 813 as a new destination which can be reached by taking device B 805 as a next hop.

Device C 813 Leaves the Network

When device C 813 leaves the network, device B 805 will be notified as it can no longer receive the route update information from device C 813. So any information related to device C 813 will be deleted from the Route Update Table and the Routing Table of device B 805. Meanwhile, device B 805 will also get the route update information from device A 801, wherein routing information to device C 813 can be found. However, since device B 805 recognizes that the immediate neighbor of device C 813 is in fact device B 805 itself so device B 805 will ignore this piece of information. Next, device A 801 will also get the route update information from device B 805. This time device A 801 will note that the route through device B 805 to device C 813 no longer exists and device A 801 will also delete the device C 813 entry from its Routing Table and delete the route update entries under device B 805 that device C 813 can be reached in 1 hop from device B 805 because device C 813 no longer exists in the route update information of device B 805. Eventually, the Route Update Tables and Routing Tables of device A 801 and device B 805 will be restored to those shown in table 2 and table 3.

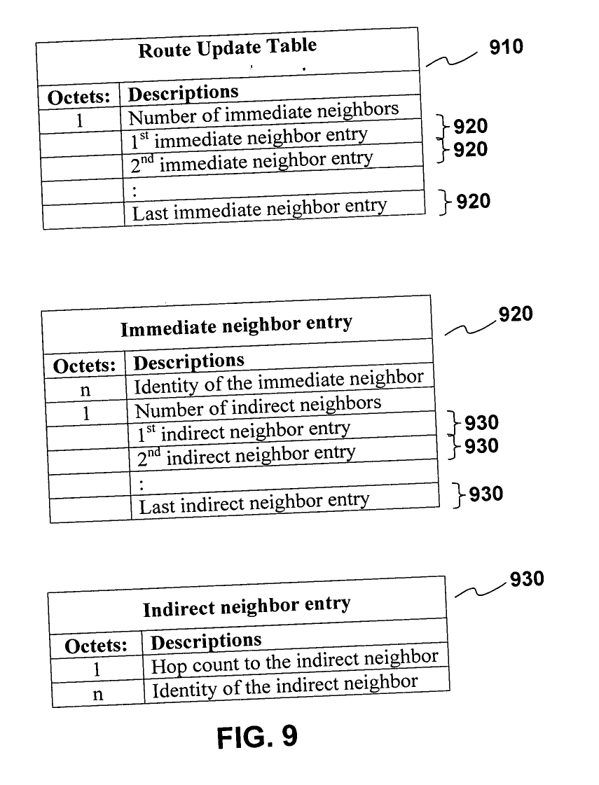

The detailed structure of the Route Update Table stored, i.e. the route update information transferred by each device is illustrated in FIG. 9. As shown in table 910, it contains an octet entry which states the number of immediate neighbor entries for this particular device. Under this octet entry, it will be a list of immediate neighbor entries 920. Each immediate neighbor entry 920 will further contain an n-octet long entry to state its identity, an octet entry which states the number of indirect neighbor for this particular immediate neighbor entry and a list of indirect neighbor entries 930 for every indirect neighbor that it can go through this particular immediate neighbor entry. Then, for each listed indirect neighbor entry 930, there is an octet entry stating the hop count to reach that particular indirect neighbor and an n-octet entry for storing the identity of the indirect neighbor. The variable n stands for the number of octets required to represent the identity.

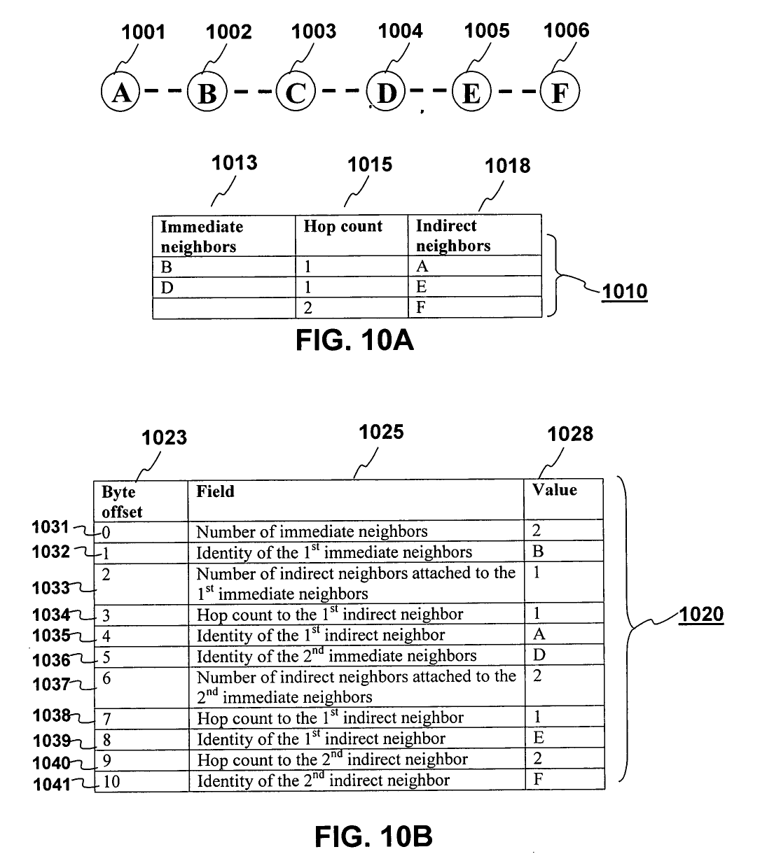

As an example, a linear network connecting devices in the sequence of device A 1001, device B 1002, device C 1003, device D 1004, device E 1005 and device F 1006 is considered. Then device C 1003 will have a Route Update Table 1010 as illustrated in FIG. 10A. The Route Update Table 1010 consists of information for immediate neighbors 1013, hop count 1015 for each immediate neighbor 1013 and indirect neighbors 1018 which can be reached from each immediate neighbor 1013. Device B 1002 and Device D 1004 are the immediate neighbors 1013 of device C 1003. Device A 1001 is the indirect neighbor 1018 of device C 1003 via device B 1002. Device E 1005 and F 1006 are the indirect neighbors 1018 of device C 1003 via device D 1004. Assuming the number of bytes required to identify the device is 1, then how the information is organized in the Route Update 1020 is illustrated in FIG. 10B. As shown in FIG. 10B, the field 1025 describes what sort of information is stored in the Route Update 1020. The position of each information is described by the byte offset 1023. The value 1028 shows the values stored for each field in this example. The first byte 1031 represented by a byte offset 1023 of 0. is the number of immediate neighbors which is 2 (devices B 1002 and D 1004). The 2^{nd} byte 1032 represented by a byte offset 1023 of 1 is the identity of one of the immediate neighbors, for example, device B 1002. The 3^{rd} byte 1033 represented by a byte offset 1023 of 2 is the number of indirect neighbors attached to the 1^{st} immediate neighbor, which is 1 for device B 1002. The 4^{th} byte 1034 represented by a byte offset 1023 of 3 is the hop count to the 1^{st} indirect neighbor from the 1^{st} immediate neighbor, which is 1. The 5^{th} byte 1035 represented by a byte offset 1023 of 4 is the identity of the 1^{st} indirect neighbor of the 1^{st} immediate neighbor, which is device A 1001. The 6^{th} byte 1036 represented by a byte offset 1023 of 5 is the identity of the 2^{nd} immediate neighbor, which is device D 1004. The 7^{th} byte 1037 represented by a byte offset 1023 of 6 is the number of indirect neighbors attached to the 2^{nd} immediate neighbor, which is 2. The 8^{th} byte 1038 represented by a byte offset 1023 of 7 is the hop count to the 1^{st} indirect neighbor from the 2^{nd} immediate neighbor, which is 1. The 9^{th} byte 1039 represented by a byte offset 1023 of 8 is the identity of the 1^{st} indirect neighbor of the 2^{nd} immediate neighbor, which is device E 1005. The 10^{th} byte 1040 represented by a byte offset 1023 of 9 is the hop count to the 2^{nd} indirect neighbor from the 2^{nd} immediate neighbor, which is 2. The 11^{th} byte 1041 represented by a byte offset 1023 of 10 is the identity of the 2^{nd} indirect neighbor of the 2^{nd} immediate neighbor, which is device F 1006. The total number of bytes in this example is 11.

The number of bytes in the route update of any particular device in the claimed invention, S_{LRP}, whereas the number of bytes required for storing number of immediate neighbors and indirect neighbors and the hop count is assumed to be 1 in the following example. That means it can at most cater for 255 neighbors and 255 hops. For other implementations, for example, 2 bytes can be used for storing the number of neighbors. Then in such a case, 65536 immediate neighbors or indirect neighbors can be stored at most:

$$\begin{matrix}{S}_{LRP} = Number of bytes required for + \\ storing number of immediate neighbors \\ Number of bytes required for all immediate \\ and indirect neighbors entries \\ = 1 + ( n + 1 ) * M + ( n + 1 ) * {N}^{′} \\ = 1 + ( n + 1 ) * ( M + N )\end{matrix}$$

where

n=the size of the identity.

M=number of immediate neighbors.

N=number of indirect neighbors.

For the linear network example of devices A 1001, B 1002, C 1003, D 1004, E 1005, F 1006 in FIG. 10A as described in the paragraph above, the number of bytes sent by device C 1003 can be found by this formula with n=1, M=2, N=3:

S_{LRP}=1+(n+1)*(M+N)=11

According to an embodiment of the claimed invention, a hold down mechanism is incorporated to the data routing method to further tackle the loop-to-infinity problem. The hold down method makes use of a timer and the timer is started when the device first detect an immediate neighbor is lost. That device will discard any subsequent route messages received from other devices that indicate the lost device is still reachable until the timer expires.

When compared with a link state routing protocol, like OSPF or OLSR, the implementation cost of the claimed invention is much lower. The implementation cost includes the one-time development cost and-the manufacturing cost per unit. Since the algorithm of the claimed invention is much simpler, the development time required to implement the claimed invention is much shorter. As illustrated in the previous calculation for the number of bytes required, the claimed invention uses less data and utilizes channel resources more efficiently. Moreover, in the claimed invention, none of the devices has the knowledge on the global view of the network. So it is unnecessary for any single device to build up the global view of the network. The information each device need to process is comparatively less than those required in link state routing. In the claimed invention, the next stop to a destination on the shortest path is also determined on the fly and there is no need to run another shortest path algorithm to find out which path to use beforehand. While for the manufacturing cost, in the case of implementing the algorithm by software running on a processor, the manufacturing cost depends on the memory requirement and the speed requirement of the processor. The simpler the algorithm is, the less the memory and processing power is required to implement the algorithm and thus the lower the cost becomes. The manufacturing cost for the claimed invention is also lower because the claimed invention is a simpler algorithm and each device needs to store only the Route Update Table and the Routing Table of immediate and indirect neighbors. The information in exchange with all immediate neighbor devices is much less than those in OSPF or OLSR.

The description of preferred embodiments of the claimed invention are not exhaustive and any update or modifications to them are obvious to those skilled in the art, and therefore reference is made to the appending claims for determining the scope of the claimed invention.

### INDUSTRIAL APPLICABILITY

The disclosed method and related device have industrial applicability in the computing and computer networking arts. The disclosed method and related device provide in data routing.

We claim:

1. A method for data routing among a network of devices, comprising the steps of:
(a) broadcasting by each device an outgoing route update table including entries corresponding to each immediate neighbor, each said entry including:
the identity of each said immediate neighbor;
the identity of each indirect neighbor that can be reached by a minimum distance through said immediate neighbor; and
the minimum distance away from each said indirect neighbor through said immediate neighbor;
(b) receiving by each other device said outgoing route update table as an incoming route update table;
(c) renewing said outgoing route update table in each device based on said incoming route update tables, wherein an entry is ignored if the identity of the immediate neighbor in said entry is identical to said device; and
(d) repeating steps (a) to (c) periodically.

2. The method according to claim 1, further comprising the step of computing a routing table after said receiving by route update tables step, said routing table includes entries corresponding to each indirect neighbor, each said entry includes:
the identity of each said indirect neighbor; and
the identity of the immediate neighbor through which said respective indirect neighbor can be reached by a minimum distance.

3. The method according to claim 1, wherein said step of renewing the outgoing route update table in each device additionally comprises the substeps of:
determining the indirect neighbor that can be reached by a minimum distance through said immediate neighbor; and
computing the minimum distance to each said indirect neighbor by selecting the minimum value.

4. The method according to claim 1, wherein said step of renewing the outgoing route update table in each device additionally comprises the substeps of:
comparing the identity of the immediate neighbor for an entry in an incoming route update table and the identity of the device; and
ignoring said entry in an incoming route update table if said identity of the immediate neighbor matches said identity of the device.

5. The method according to claim 1, further comprising the step of holding down for a predetermined length of time after a device detects an immediate neighbor has left, such that any information in incoming route update tables corresponding to the departed immediate neighbor is ignored.

6. The method according to claim 2, further comprising the steps of:
retrieving a destination information for a data packet;
looking up an entry in said routing table for indirect neighbor that matches said destination information;
determining the immediate neighbor as a next stop from said entry; and
forwarding said data packet to said immediate neighbor.

7. The method according to claim 1 is incorporated with a protocol selected from a group of protocols consisting of Wimedia, distributed MAC protocol over UWB, WiFi, Zigbee and Bluetooth.

8. A data routing method, comprising:
retrieving information of one or more network devices according to an incoming route update table received from an immediate device;
grouping said one or more network devices into immediate devices and indirect devices by comparing a local route update table with said incoming route update table;
assigning said indirect devices to said immediate devices; and
computing an outgoing route update table.

9. The data routing method according to claim 8, further comprising the following steps for computing said outgoing route update table:
storing data for quantity of said immediate devices; and
assigning each said immediate devices with one or more entries of said indirect devices.

10. The data routing method according to claim 9, further comprising:
retrieving a destination information for a data packet;
looking for an entry containing said destination information in said local routing table;
determining a next stop for said destination information from said entry; and
forwarding said data packet to said immediate devices.

11. The data routing method according to claim 9, further comprising:
relating said indirect devices to said immediate devices with hop counts in said outgoing route update table.

12. The data routing method according to claim 9, further comprising:
sending said outgoing route update table to said immediate devices.

13. The data routing method according to claim 9 is incorporated with a protocol selected from a group of protocols consisting of Wimedia distributed MAC protocol over UWB, WiFi, Zigbee and Bluetooth.

14. A device for data routing among a network of devices, comprising:
(a) a communication module for broadcasting by each device an outgoing route update table including entries corresponding to each immediate neighbor, each said entry including:
the identity of each said immediate neighbor;
the identity of each indirect neighbor that can be reached by a minimum distance through said immediate neighbor; and
the minimum distance away from each said indirect neighbor through said immediate neighbor;
and for receiving said outgoing route update tables from other devices as incoming route update tables;
(b) a processing unit for renewing the outgoing route update table in each device based on said incoming route update tables, wherein an entry is ignored if the identity of the immediate neighbor in said entry is identical to said device;; and
(c) a first memory unit for storing said incoming and outgoing route update tables.

15. The device according to claim 14, further comprising a second memory unit for storing a routing table, said processing unit further updates said routing table with entries corresponding to each indirect neighbor, each said entry includes:
the identity of each said indirect neighbor; and
the identity of the immediate neighbor through which said respective indirect neighbor can be reached by a minimum distance.

16. The device according to claim 14, said processing unit further performs the tasks including:
determining the indirect neighbor that can be reached by a minimum distance through said immediate neighbor; and
computing the minimum distance from each said indirect neighbor by selecting the minimum value.

17. The device according to claim 14, said processing unit further performs the tasks including:
comparing the identity of the immediate neighbor for an entry in an incoming route update table and the identity of the device; and
ignoring said entry in an incoming route update table if said identity of the immediate neighbor matches said identity of the device.

18. The device according to claim 14, further comprising a timer for counting a predetermined length of time after a device detects an immediate neighbor has left, said processing unit further performs the task of holding down when said timer is counting, such that any information in said incoming route update tables corresponding to the departed immediate neighbor is ignored.

19. The device according to claim 15, said processing unit further performs the tasks including:
retrieving a destination information for a data packet;
looking up an entry in said routing table for indirect neighbor that matches said destination information;
determining the immediate neighbor as a next stop from said entry; and
forwarding said data packet to said immediate neighbor.

20. The device according to claim 14 perform network communication by a protocol selected from a group of protocols consisting of Wimedia, distributed MAC protocol over UWB, WiFi, Zigbee and Bluetooth.
